(19) United States
(12) Patent Application Publication
(10) Pub. No.: US 2025/0044130 A1
(43) Pub. Date: Feb. 6, 2025

(54) OPTICAL POSITION-MEASURING DEVICE

(71) Applicant: JOHANNES HEIDENHAIN GmbH, Traunreut (DE)

(72) Inventors: Michael HERMANN, Tacherting (DE); Michael KUGLER, Trostberg (DE)

(21) Appl. No.: 18/786,611

(22) Filed: Jul. 29, 2024

(30) Foreign Application Priority Data
Jul. 31, 2023 (DE) 10 2023 207 288.2
Jun. 6, 2024 (DE) 10 2024 001 846.8

(51) Int. Cl. G01D 5/38; G01D 5/347

(52) U.S. Cl. CPC G01D 5/38; G01D 5/34707

(57) ABSTRACT

An optical position-measuring device for determining a relative position of two objects that are movable relative to one another along two measurement directions includes scanning units which are connected to one of the two objects and each include a light source, one or more gratings, and a detector assembly, and a scale which is connected to the other object. The scale includes a two-dimensional measuring graduation composed of structure elements which are periodically arranged along the measurement directions and have different optical properties, and reference marks which are integrated into the measuring graduation and have periodic and aperiodic sub-regions. Scanning of a respective reference mark allows a respective reference signal to be generated at a defined reference position along a measurement direction. The periodic sub-regions of the reference marks have a higher scanning efficiency than the surrounding measuring graduation.

### CROSS REFERENCE TO RELATED APPLICATIONS

This application claims benefit to German Patent Application No. DE 10 2023 207288.2, filed on Jul. 31, 2023 and German Patent Application No. DE 10 2024 001 846.8, filed on Jun. 6, 2024, which are each hereby incorporated by reference herein.

### FIELD

The present invention relates to an optical position-measuring device suitable for determining with high accuracy the relative position of two objects that are movable relative to one another.

### BACKGROUND

DE 10 2004 006 067 A1 describes a position-measuring device suitable for determining the relative position of two objects that are movable relative to one another along at least two measurement directions. To this end, the position-measuring device includes a plurality of scanning units which are connected to one of the two objects and each include at least one light source, one or more gratings, as well as a detector assembly. The position-measuring device further includes a scale connected to the other object. The scale includes a measuring graduation in the form of a two-dimensional cross grating formed by two superimposed periodic incremental graduations extending along the two measurement directions. The cross grating has two reference marks integrated therein, the scanning of which allows a respective reference signal to be generated at a defined reference position along each measurement direction. The use of reference marks which are integrated into the cross grating makes it possible to generate reference signals along a first measurement direction independently of the position of the scanning unit(s) along a second measurement direction and vice versa.

An optical position-measuring device having reference marks integrated into a plurality of measuring graduations is also known from EP 3 527 951 B1. The reference marks provided here include aperiodic and periodic sub-regions. The periodic sub-regions are configured identically to the surrounding measuring graduation; the aperiodic sub-regions are formed by chirped grating structures arranged symmetrically with respect to a central axis of symmetry.

However, with regard to the generation of the reference signals, the known approaches with reference marks integrated into the measuring graduations exhibit certain problems. For example, the signal levels of the generated incremental signals fall more or less significantly when the scanning units pass over the respective reference marks. A known way to avoid this is to increase the optical power of the light source during passage over the reference mark. This, however, reduces the so-called control reserve for the light source; i.e., the light source current is then no longer fully available to compensate for other negative effects, such as aging and/or soiling.

### SUMMARY

In an embodiment, the present disclosure provides an optical position-measuring device for determining a relative position of two objects that are movable relative to one another along at least a first and a second measurement direction. The optical position-measuring device includes a plurality of scanning units which are connected to a first one of the two objects and each include at least one light source, one or more gratings, and a detector assembly, and a scale which is connected to a second one of the two objects. The scale includes a two-dimensional measuring graduation composed of structure elements which are periodically arranged along the first and second measurement directions and have different optical properties, and a plurality of reference marks which are integrated into the measuring graduation and have periodic and aperiodic sub-regions. Scanning of a respective one of the reference marks allows a respective reference signal to be generated at a defined reference position along one of the measurement directions. At least the periodic sub-regions of the reference marks have a higher scanning efficiency than a surrounding part of the measuring graduation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a highly schematic plan view of a first exemplary embodiment of the optical position-measuring device according to the invention with a measuring graduation configured as a two-dimensional cross grating having three reference marks integrated therein, and with four scanning units;

FIG. 2 is a plan view of a portion of the reference mark of the exemplary embodiment of FIG. 1;

FIG. 3a is a schematic sectional view showing the scanning beam path of a scanning unit of the position-measuring device according to an embodiment of the invention;

FIG. 3b is a plan view of the scanning unit shown in FIG. 3a;

FIG. 4 is a highly schematic plan view of another exemplary embodiment of the optical position-measuring device according to the invention with a measuring graduation configured as a two-dimensional cross grating having two reference marks integrated therein, and with three scanning units;

FIG. 5 is a plan view of a portion of the reference mark of another exemplary embodiment of the optical position-measuring device according to the invention; and

FIGS. 6a and 6b are each sectional views of the measuring graduation in the area of the reference mark from the exemplary embodiment of FIG. 5.

### DETAILED DESCRIPTION

Embodiments of the present invention provide an optical position-measuring device for high-accuracy position determination along at least two measurement directions, where the generation of periodic incremental signals with the smallest possible signal dip is ensured even during passage over reference marks that are integrated into the measuring graduation.

The optical position-measuring device according to embodiments of the present invention is used to determine the relative position of two objects that are movable relative to one another along at least two measurement directions. It includes a plurality of scanning units which are connected to one of the two objects and each include at least one light source, one or more gratings, as well as a detector assembly. Also provided is a scale connected to the other object. The scale includes a two-dimensional measuring graduation composed of structure elements which are periodically arranged along the two measurement directions and have different optical properties. The measuring graduation has integrated therein a plurality of reference marks having periodic and aperiodic sub-regions, the scanning of a reference mark allowing a respective reference signal to be generated at a defined reference position along a measurement direction. At least the periodic sub-regions of the reference marks have a higher scanning efficiency than the surrounding measuring graduation.

The measuring graduation may have integrated therein two rectangular reference marks arranged in the shape of an L, one reference mark being associated with a first measurement direction, and another reference mark being associated with a second measurement direction oriented orthogonal to the first measurement direction.

Alternatively, it may be provided that the measuring graduation has integrated therein three rectangular reference marks arranged in the shape of a U, two reference marks being associated with one measurement direction, and another reference mark being associated with a different measurement direction oriented orthogonal to the first measurement direction.

It has been found to be advantageous if the reference marks are arranged in the respective peripheral regions of the measuring graduation.

In this case, each reference mark associated with a measurement direction may be spaced from the edge of the measuring graduation by a distance smaller than the distance between two adjacent scanning units along this measurement direction.

In another embodiment, it may be provided that
a first scanning unit is associated with the first measurement direction, and a second and a third scanning unit are associated with the second measurement direction,
the second and third scanning units not being offset along the second measurement direction.

In another embodiment, it may be provided that
four scanning units are disposed on the other object opposite the measuring graduation,
a first and a fourth scanning unit being associated with the first measurement direction, and a second and a third scanning unit being associated with the second measurement direction, and
the two scanning units associated with one measurement direction not being offset along the second measurement direction.

Furthermore, it is possible that the periodic sub-regions of the reference marks each have arranged therein a one-dimensional incremental graduation that has an increased scanning efficiency in the form of a higher diffraction efficiency as compared to the surrounding measuring graduation.

In this case, the one-dimensional incremental graduation in the periodic sub-regions of the reference marks only causes diffraction into +/−1^{st} diffraction orders along one measurement direction, while in the surrounding measuring graduation, diffraction into +/−1^{st} diffraction orders results along two measurement directions.

Preferably, both the incremental graduation in the periodic sub-regions of the reference marks and the surrounding measuring graduation are configured as reflection phase gratings.

Alternatively, it may also be provided that the periodic sub-regions and the aperiodic sub-regions of the reference marks have an increased scanning efficiency in the form of a higher reflectivity as compared to the surrounding measuring graduation.

In this case, the periodic sub-regions of the reference marks have arranged therein a cross grating which, like the surrounding measuring graduation, is configured as a reflection phase grating, both the periodic sub-regions and the aperiodic sub-regions of the reference marks being provided with a reflection-enhancing coating.

Furthermore, it is possible that the aperiodic sub-regions of the reference marks each have chirped grating structures in which the grating periods vary spatially symmetrically with respect to a central axis of symmetry.

It may also be advantageously provided that the periodic sub-regions of the reference marks and the aperiodic sub-regions of the reference marks are arranged periodically in a direction perpendicular to a measurement direction.

It is also possible that the periodic sub-regions and the aperiodic sub-regions of the reference marks have a surface area ratio different from 1:1.

In a possible embodiment, it may further be provided that the periodic sub-regions of the reference marks have arranged therein one-or two-dimensional periodic grating structures whose periodicities along one or two measurement directions are equal to the periodicities of the surrounding measuring graduation along the one or two measurement directions.

The optical position-measuring device according to embodiments of the invention has been found to be especially advantageous in that no significant dip in the signal level of the periodic incremental signals will result anymore, even during passage over the reference marks that are integrated into the measuring graduation. This eliminates the need to increase the light source current; the control reserve is fully available to compensate for the effects of aging or soiling, for example.

Further details and advantages of embodiments of the present invention will be described in the following description of exemplary embodiments of the inventive device in conjunction with the figures.

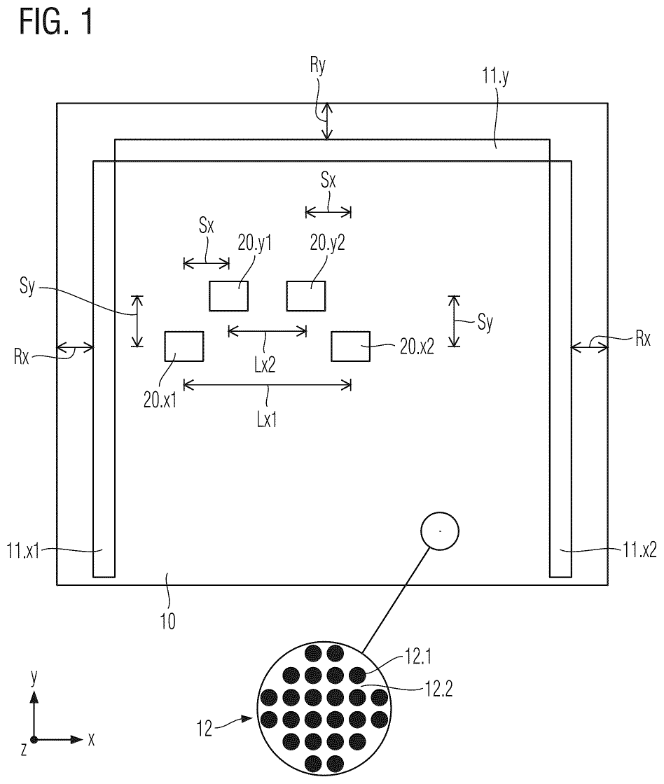

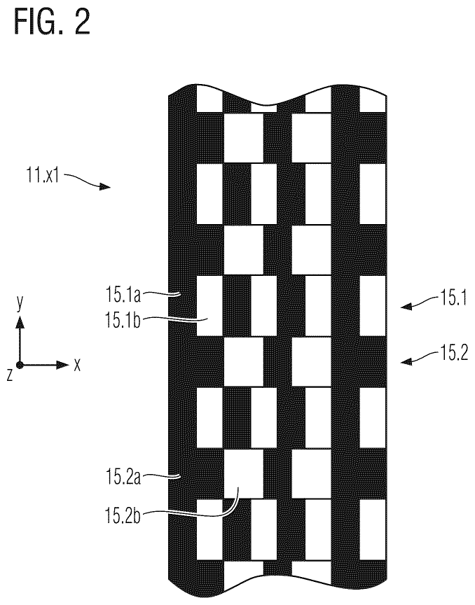

An exemplary embodiment of the optical position-measuring device according to the invention will now be described with reference to FIGS. 1, 2 as well as 3a and 3b.

The position-measuring device shown in FIG. 1 is used to determine the relative position of two objects that are movable relative to one another along the two measurement directions x, y. In the present case, the two measurement directions x, y are oriented orthogonal to each other. In the following, measurement direction x will also be referred to as the first measurement direction, and measurement direction y as the second measurement direction. The objects may be machine components that are movable relative to each other, such as the table and tool of a semiconductor processing machine.

A scale 10 of the position-measuring device, which scale has a two-dimensional reflective measuring graduation 12 on a scale carrier, is connected to one of the two objects. In the present case, the two-dimensional measuring graduation 12 is configured as what is known as a cross grating and is composed of structure elements 12.1, 12.2 which are periodically arranged along the two measurement directions x, y and have different optical properties. In this regard, reference is made, in particular, to the enlarged schematic view of a portion of measuring graduation 12 in the lower portion of FIG. 1. In the reflected-light system shown, measuring graduation 12 is configured as a reflection phase grating, in which structure elements 12.1, 12.2 exert different phase-shifting effects on the reflected beams. In a specific embodiment, a chromium echelon grating having a phase shift of 180° and a periodicity of 8 μm along the two measurement directions x, y may function as the reflection phase grating. By optically scanning measuring graduation 12, periodic incremental signals are generated along the two measurement directions x, y, the respective periodic incremental signals being a measure of the relative movement of the two objects along the corresponding measurement direction x, y. Measuring graduation 12 has a plurality of reference marks 11.x1, 11.x2, 11.y integrated therein. In the present case, three rectangular reference marks 11.x1, 11.x2, 11.y are provided and arranged in the shape of a U; i.e., the three reference marks 11.x1, 11.x2, 11.y are arranged parallel to three edges in the peripheral regions of measuring graduation 12. From the optical scanning of reference marks 11.x1, 11.x2, 11.y, a respective reference signal is generated at a defined reference position along one of the two measurement directions x, y. By arithmetically combining the reference signals with the incremental signals, high-resolution absolute position information can be generated in a known manner along the two measurement directions x, y. The specific configuration of reference marks 11.x1, 11.x2, 11.y with periodic and aperiodic sub-regions arranged in a particular way will be described in detail below with reference to FIG. 2. The position signals generated in the form of periodic incremental signals and reference signals by the optical position-measuring device according to an embodiment of the invention are further processed by a downstream control unit and used by it to control the relative movement of the corresponding machine parts.

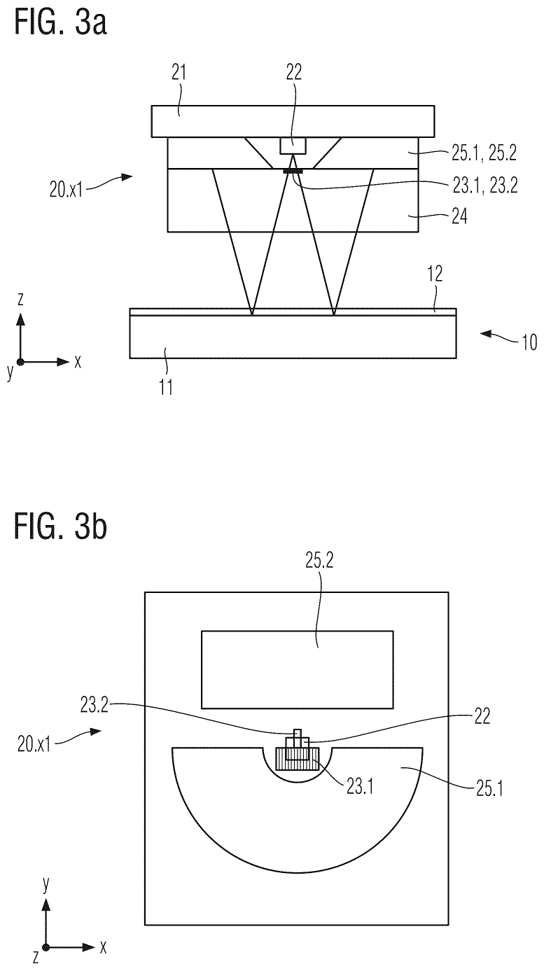

The other of the two objects has connected thereto a plurality of scanning units 20.x1, 20.x2, 20.y1, 20.y2 of the optical position-measuring device according to an embodiment of the invention. In this example, a total of four scanning units 20.x1, 20.x2, 20.y1, 20.y2 are provided. Scanning units 20.x1, 20.x2, 20.y1, 20.y2 each include at least one light source, one or more gratings, as well as a detector assembly. With the aid of scanning units 20.x1, 20.x2, 20.y1, 20.y2, measuring graduation 12 is optically scanned, and the incremental and reference signals are generated along the two measurement directions x, y. With regard to the specific design of scanning units 20.x1, 20.x2, 20.y1, 20.y2, reference is made to the description of FIGS. 3a and 3b to follow further below.

In the optical position-measuring device according to an embodiment of the invention, the various scanning units 20.x1, 20.x2, 20.y1, 20.y2 are arranged relative to each other in a specific way, which will be described below for the example shown. In this context, the four scanning units 20.x1, 20.y1, 20.y2, 20.x2 provided are designated, starting from the left, as the first, second, third, and fourth scanning unit 20.x1, 20.y1, 20.y2, 20.x2.

In the present case, first scanning unit 20.x1 and fourth scanning unit 20.x2 are associated with first measurement direction x, and these two scanning units 20.x1, 20.x2 have a distance L×1 from each other along first measurement direction x and are not offset from each other along second measurement direction y, i.e., are disposed at the same level along second measurement direction y.

Associated with second measurement direction y are second scanning unit 20.y1 and third scanning unit 20.y2, which have a distance L×2 from each other along measurement direction x and are not offset from each other along second measurement direction y. As can be seen from the figure, second and third scanning units 20.y1, 20.y2 are disposed along measurement direction x between first and fourth scanning units 20.x1, 20.x2.

First scanning unit 20.x1 is disposed, relative to second scanning unit 20.y1, at a distance Sx along first measurement direction x and at a distance Sy along second measurement direction y.

As already mentioned above, in the example of FIG. 1, measuring graduation 12 has integrated therein three rectangular reference marks 11.x1, 11.x2, 11.yarranged in the shape of a U. In analogy to the designation of the various scanning units 20.x1, 20.x2, 20.y1, 20.y2, the three reference marks 11.x1, 11.y, 11.x2 provided are designated, starting from the left, as the first, second, third reference mark 11.x1, 11.y, 11.x2.

First reference mark 11.x1 and third reference mark 11.x2 are associated with first measurement direction x, the longitudinal axes of these two reference marks 11.x1, 11.x2 extending along second measurement direction y. Thus, first reference mark 11.x1 and third reference mark 11.x2 allow referencing with respect to movements along first measurement direction x. Second reference mark 11.y is associated with second measurement direction y; its longitudinal axis extends along first measurement direction x. Therefore, referencing with respect to movements along second measurement direction y can be accomplished with the aid of second reference mark 11.y. From the scanning of first and third reference marks 11.x1, 11.x2, a respective reference signal can be generated at specific reference positions along first measurement direction x. By scanning second reference mark 11.y, a reference signal can be generated at a predefined reference position along second measurement direction y.

As for the arrangement of the three reference marks 11.x1, 11.x2, 11.y in the peripheral regions of measuring graduation 12, provision is made in the example shown that the reference mark 11.x1, 11.x2 or 11.y associated with a measurement direction x or y is spaced from the adjacent edge of measuring graduation 12 by a distance Rx or Ry smaller than the distance Sx or Sy between two adjacent scanning units 20.x1, 20.y1 along this measurement direction x, y. This means that the distance Rx of reference marks 11.x1, 11.x2 from the respective nearest edge of measuring graduation 12 is selected to be smaller than distance Sx, which indicates the distance between the two adjacent scanning units 20.x1, 20.y1 and between the two adjacent scanning units 20.x2, 20.y2 along first measurement direction x. Analogously, the distance Ry of reference mark 11.y from the adjacent edge of measuring graduation 12 is selected to be smaller than distance Sy, which indicates the distance between the two adjacent scanning units 20.x1, 20.y1 and between the two adjacent scanning units 20.x2, 20.y2 along second measurement direction y.

In the example shown, the arrangement of scanning units 20.x1, 20.x2, 20.y1, 20.y2 and reference marks 11.x1, 11.x2, 11.y as described enables position determination during displacements of the objects along the two measurement directions x, y and during rotation of the objects about an axis z that is oriented perpendicular to the two measurement directions x, y. Furthermore, any possible thermal expansion of the scale 10 can be detected with such a number and arrangement of reference marks 11.x1, 11.x2, 11.y and scanning units 20.x1, 20.x2, 20.y1, 20.y2.

Further options regarding the number and arrangement of scanning units and reference marks in the optical position-measuring device according to embodiments of the invention will be outlined further below in the description.

The configuration of the reference marks in the optical position-measuring device according to an embodiment of the invention will now be described with reference to FIG. 2. FIG. 2 shows a highly schematic detail view of first reference mark 11.x1 from FIG. 1. The figure only shows details of the provided structure in a small area along the direction of longitudinal extent y of reference mark 11.x1. FIG. 2 is not a true-to-scale representation of reference mark 11.x1, but merely serves to illustrate the basic configuration of reference mark 11.x1.

As indicated earlier herein, the reference marks of the device according to an embodiment of the invention are composed of periodic sub-regions 15.1 and aperiodic sub-regions 15.2. Like the surrounding measuring graduation, the various sub-regions 15.1, 15.2 of the reference marks are configured as reflection phase gratings and each have a rectangular geometry, as shown in the plan view of FIG. 2. The longitudinal axes of the rectangular periodic and aperiodic sub-regions 15.1, 15.2 of reference mark 11.x1 are oriented perpendicular to the longitudinal axis of reference mark 11.x1. This means that, in this reference mark, the longitudinal axes of the various rectangular sub-regions 15.1, 15.2 extend parallel to first measurement direction x, and the longitudinal axis of reference mark 11.x1 extends parallel to second measurement direction y. Along the longitudinal axis of reference mark 11.x1, sub-regions 15.1, 15.2 of reference mark 11.x1 are arranged periodically; i.e., periodic sub-regions 15.1 and aperiodic sub-regions 15.2 are alternately arranged along direction y. Within a reference mark 11.x1, periodic sub-regions 15.1 and aperiodic sub-regions 15.2 have a surface area ratio different from 1:1; i.e., reference mark 11.x1 is composed of periodic and aperiodic portions in unequal proportions. Accordingly, the ratio of the surface areas of periodic and aperiodic sub-regions 15.1, 15.2 is selected to be different from 0.5. In a possible embodiment, the surface area ratio of periodic and aperiodic sub-regions 15.1, 15.2 may be selected in a range of greater than or equal to 0.25 and less than 0.5; i.e., the periodic portions take up a greater amount of surface area than the aperiodic portions. Such choice of the surface area ratio results, first of all, in an increased reference signal. Especially in combination with amplitude control of the incremental signal, the reference signal is further improved since the principal maximum of the reference signal is increased as compared to the secondary maxima of the reference signal.

To this end, a preferred embodiment provides, for example, that the width of periodic sub-regions 15.1 along second measurement direction y is 18 μm and that the width of aperiodic sub-regions 15.2 along second measurement direction y is 22 μm. In the case of such dimensioning, the resulting ratio of surface areas between periodic and aperiodic sub-regions 15.1, 15.2 in reference mark 11.x1 is 0.45.

Such a reference mark periodicity of 40 μm, which is small in comparison with the signal-contributing region of the measuring graduation, proves advantageous, especially when the scanning units pass obliquely across the reference mark. Reference mark periodicities of less than or equal to 128 μm, in particular of less than or equal to 64 μm, are particularly suitable. As a result, the variation of the sub-areas of aperiodic and periodic sub-regions, which sub-areas are involved in the signal generation, is small. This results in an improved signal-to-noise ratio of the reference signals and an improved amplitude variation of the incremental signals. These advantages come into play even if the scanning unit can enter the reference mark area at different y-positions during straight crossing, as is the case with 2D measuring systems.

In FIG. 1, second and third reference marks 11.y, 11.x2 are basically identical in configuration to first reference mark 11.x1, with second reference mark 11.ybeing rotated 90 degrees relative thereto and extending along first measurement direction x.

Aperiodic sub-regions 15.2 of reference mark 11.x1 each have what is known as chirped grating structures. This means that the structure elements 15.2a, 15.2b having different optical properties are not arranged strictly periodically along the respective longitudinal axis of the rectangle, but are arranged with spatially varying grating periods in the respective sub-region 15.2. Specifically, the present example provides that the grating periods vary spatially symmetrically with respect to a central axis of symmetry of sub-region 15.2, it being provided that the grating periods increase outwardly from the axis of symmetry.

The desired properties of the reference marks 11.1x integrated into the measuring graduation are determined by the configuration of the periodic sub-regions 15.1 of reference marks 11.x1. In this regard, it is provided that at least these sub-regions 15.1 have a higher scanning efficiency than the surrounding measuring graduation. In this way, it can be ensured that no significant dip in the levels of the incremental signals will result during passage over a reference mark 11.x1 and that therefore there will be no need to increase the light source current.

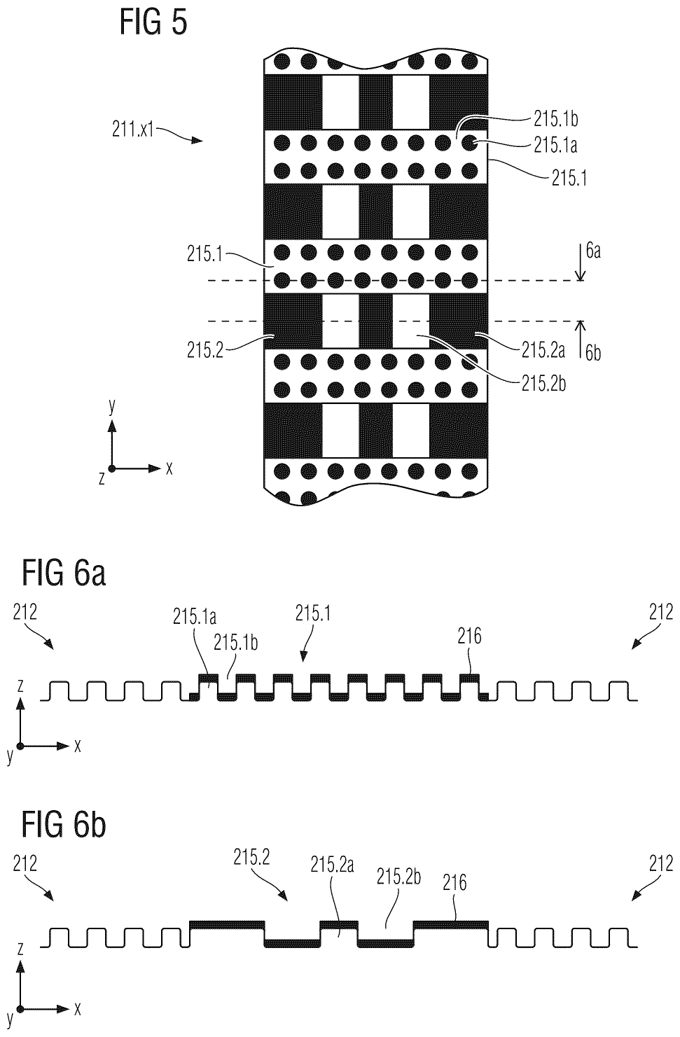

In order to ensure a higher efficiency in scanning the periodic sub-regions of the reference marks, there are various possibilities. A first variant will be described with reference to the example in FIG. 2, another possibility will be described further below in the description with the aid of FIGS. 5, 6a, 6b. In the example of FIG. 2, provision is made that a one-dimensional incremental graduation is arranged in periodic sub-regions 15.1 of reference mark 11.x1, the one-dimensional incremental graduation having a higher diffraction efficiency than the surrounding two-dimensional measuring graduation. As can be seen from FIG. 2, the one-dimensional incremental graduation in periodic sub-regions 15.1 is composed of a periodic arrangement of structure elements 15.1a, 15.1b having different optical properties along first measurement direction x; the periodicity of this incremental graduation is selected to be identical to the periodicity of the cross grating along measurement direction x. The different structure elements 15.1a, 15.1b exert different phase-shifting effects on the reflected beams. In a possible embodiment, the incremental graduation may, for example, be configured as a chromium echelon grating and have a phase shift of 180°.

The one-dimensional incremental graduation in periodic sub-regions 15.1 of reference mark 11.x1 substantially causes diffraction into +/−1^{st} diffraction orders along measurement direction x; the incident intensity is mainly divided into these two diffraction orders in reflection. If, in contrast, a two-dimensional measuring graduation were arranged in the periodic sub-regions of the reference mark, diffraction in the +/−1^{st} diffraction orders would result along the two measurement directions x, y; i.e., the incident intensity would consequently be divided into four reflected diffraction orders. The undesirable consequence would be a significant dip in the incremental signal during passage over reference mark 11.x1.

The scanning beam path in the optical position-measuring device according to an embodiment of the invention will now be described with reference to FIGS. 3a and 3b. This is done using the sectional view of FIG. 3a, which shows the scanning beam path of first scanning unit 20.x1 from FIG. 1 in the xz-plane, and using a plan view of the detection plane of this scanning unit 20.x1. The scanning beam path or configuration of fourth scanning unit 20.x2 from FIG. 1 is basically identical to this scanning beam path. Rotated 90° about the z-axis are the scanning beam paths of second and third scanning units 20.y1, 20.y2, via which movement along second measurement direction y is detected.

In the illustrated scanning unit 20.x1 of the position-measuring device, a light source 22 and, adjacent thereto, a detector assembly including an incremental signal detector 25.1 and a reference signal detector 25.2 are provided on a carrier element 21. A transmitting grating device including a periodic, transmission-type transmitting grating 23.1 and, adjacent thereto, a transmitting slit 23.2 is disposed in front of the divergently emitting light source 22 in the direction of light propagation.

As a result of the interaction of the light beams emitted by light source 22 with the gratings provided in the scanning beam path; i.e., with transmission-type transmitting grating 23.1, transmitting slit 23.2, and measuring graduation 12, a displacement-dependent signal pattern is produced in a detection plane of the detector assembly. By optoelectronically scanning this signal pattern with the aid of scanning unit 20.x1, periodic incremental signals as well as reference signals are generated along first measurement direction x.

Also visible in FIG. 3a is the configuration of the scale 10 having the two-dimensional measuring graduation 12 arranged on a scale carrier 11.

Alternative variants of the optical position-measuring device according to other embodiments of the invention will now be described with reference to the other figures. In this connection, substantially only the relevant differences from the above-described exemplary embodiment will be discussed.

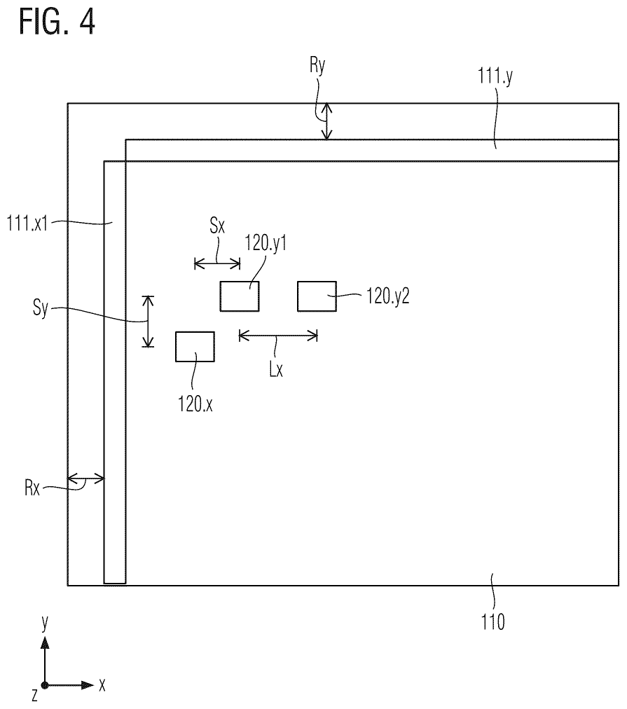

FIG. 4, for example, shows a plan view of a variant where only two reference marks 111.x, 111.yare integrated into the measuring graduation in an L-shaped arrangement. As in the previous exemplary embodiment, reference marks 111.x, 111.yare arranged in the peripheral regions of measuring graduation 12 at respective distances Rx, Ry from the edges.

On the scanning side, three scanning units 120.x, 120.y1, 120.y2 are provided here; a first scanning unit 120.xbeing associated with first measurement direction x, and a second scanning unit 120.y1 and a third scanning unit 120.y2 being associated with second measurement direction y. As can be seen from the figure, second and third scanning units 120.y1, 120.y2 are not offset along second measurement direction y, but are offset from first scanning unit 120.xby distance Sy along second measurement direction y. Second scanning unit 120.y1 is offset by distance Sx along first measurement direction x; the distance between second and third scanning units 120.y1, 120.y2 along first measurement direction x is labeled Lx in the figure.

This variant of the optical position-measuring device according to an embodiment of the invention allows detection of relative movements along first measurement direction x and along second measurement direction y and of rotation about measurement direction z. The reference marks 111.x, 111.yintegrated into the two-dimensional measuring graduations as well as the three scanning units 120.x, 120.y1, 120.y2 are configured identically to the first embodiment.

As indicated earlier herein, an alternative way of achieving an increased scanning efficiency in the sub-regions of the reference marks will be described with reference to FIGS. 5 and 6a, 6b. Analogously to FIG. 2, FIG. 5 shows a schematic detailed view of a corresponding reference mark 211.x1; FIGS. 6a, 6b each show sectional views of the measuring graduation in the area of reference mark 211.x1.

In order to increase the scanning efficiency in the area of reference mark 211.x1, it is provided here that both the periodic sub-regions 215.1 and the aperiodic sub-regions 215.2 of reference mark 211.x1 have a higher reflectivity than the surrounding measuring graduation 212.

This is accomplished with the aid of a reflection-enhancing coating 216, which is applied over the grating structures of the reflection phase grating in the entire area of reference mark 211.x1; i.e., both in periodic sub-regions 215.1 and in aperiodic sub-regions 215.2.

As in the example of FIG. 2, the grating structures in aperiodic sub-regions 215.2 are configured as chirped grating structures. In contrast to FIG. 2, a cross grating is arranged in periodic sub-regions 215.1 of reference mark 211.x1; i.e., an identical grating structure as in the surrounding measuring graduation 212. The cross grating arranged in periodic sub-regions 215.1 has the same periodicities along the two measurement directions x, y as the cross grating of the surrounding measuring graduation 212.

In a specific exemplary embodiment, the reflection phase grating in the area of reference mark 211.x1 may be configured as a chromium echelon grating having a phase shift of 180°; a titanium nitride layer functions as a reflection-enhancing coating 216.

If the reference marks are configured in this way, they do not necessarily have to be arranged in the peripheral regions in the two-dimensional measuring graduation. It would also be possible, for example, to provide two such reference marks in a 90° crossed configuration in the measuring graduation, the point of intersection coinciding with the center of the measuring graduation, and the reference marks extending parallel to the first and second measurement directions.

In addition to the exemplary embodiments described above with the aid of the figures,

other embodiments are of course possible within the scope of the present invention.

For example, in the case of a U-shaped arrangement of three reference marks in the two-dimensional measuring graduation according to FIG. 1, it is possible to provide only three scanning units on the scanning side; i.e., for example, to dispense with fourth scanning unit 20.x2 in FIG. 1. In this case, it would then only be possible to detect translational movements along the x-and y-directions as well as rotational movement about the z-direction.

Furthermore, it would be possible to design the measuring graduation as a reflection amplitude grating, etc.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An optical position-measuring device for determining a relative position of two objects that are movable relative to one another along at least a first and a second measurement direction, the optical position-measuring device comprising:
a plurality of scanning units which are connected to a first one of the two objects and each include at least one light source, one or more gratings, and a detector assembly; and
a scale which is connected to a second one of the two objects, the scale comprising:
a two-dimensional measuring graduation composed of structure elements which are periodically arranged along the first and second measurement directions and have different optical properties, and
a plurality of reference marks which are integrated into the measuring graduation and have periodic and aperiodic sub-regions, wherein scanning of a respective one of the reference marks allows a respective reference signal to be generated at a defined reference position along one of the measurement directions, and wherein at least the periodic sub-regions of the reference marks have a higher scanning efficiency than a surrounding part of the measuring graduation.

2. The optical position-measuring device as recited in claim 1, wherein the reference marks include two rectangular reference marks arranged in the shape of an L that are integrated in the measuring graduation, a first one of the two rectangular reference marks being associated with the first measurement direction, and a second one of the two rectangular reference marks being associated with the second measurement direction, which is oriented orthogonal to the first measurement direction.

3. The optical position-measuring device as recited in claim 2, wherein the scanning units include a first scanning unit that is associated with the first measurement direction, and a second and a third scanning unit that are associated with the second measurement direction, the second and third scanning units not being offset with respect to each other along the second measurement direction.

4. The optical position-measuring device as recited in claim 2, wherein the two rectangular reference marks are arranged in respective peripheral regions of the measuring graduation.

5. The optical position-measuring device as recited in claim 4, wherein the two rectangular reference marks are each spaced from a respective edge of the measuring graduation by a respective distance that is smaller than a distance between two adjacent ones of the scanning units that are disposed along a respective one of the measurement directions with which a respective one of the two rectangular reference marks is associated.

6. The optical position-measuring device as recited in claim 1, wherein the reference marks include three rectangular reference marks arranged in the shape of a U that are integrated into the measuring graduation, two of the three rectangular reference marks being associated with one of the measurement directions, and another one of the three rectangular reference marks being associated with a different one of the measurement directions, the measurement directions being oriented orthogonal to each other.

7. The optical position-measuring device as recited in claim 6, wherein:
the scanning units include four scanning units that are disposed on the first one of the two objects opposite the measuring graduation;
a first and a fourth scanning unit of the four scanning units are associated with the first measurement direction, and are not offset with respect to each other along the second measurement direction; and
a second and a third scanning unit of the four scanning units are associated with the second measurement direction, and are not offset with respect to each other along the second measurement direction.

8. The optical position-measuring device as recited in claim 6, wherein the three rectangular reference marks are arranged in respective peripheral regions of the measuring graduation.

9. The optical position-measuring device as recited in claim 8, wherein the three rectangular reference marks are each spaced from a respective edge of the measuring graduation by a respective distance that is smaller than a distance between two adjacent ones of the scanning units that are disposed along a respective one of the measurement directions with which a respective one of the three rectangular reference marks is associated.

10. The optical position-measuring device as recited in claim 1, wherein the periodic sub-regions of the reference marks each have arranged therein a one-dimensional incremental graduation that has an increased scanning efficiency in a form of a higher diffraction efficiency as compared to the surrounding part of the measuring graduation.

11. The optical position-measuring device as recited in claim 10, wherein the one-dimensional incremental graduation in the periodic sub-regions of the reference marks only causes diffraction into +/−1^{st} diffraction orders along one of the first and second measurement directions, while in the surrounding part of the measuring graduation, diffraction into +/−1 ^{st} diffraction orders results along both the first and second measurement directions.

12. The optical position-measuring device as recited in claim 11, wherein the incremental graduation in the periodic sub-regions of the reference marks and the surrounding part of the measuring graduation are configured as reflection phase gratings.

13. The optical position-measuring device as recited in claim 1, wherein the periodic sub-regions and the aperiodic sub-regions of the reference marks have an increased scanning efficiency in a form of a higher reflectivity as compared to the surrounding part of the measuring graduation.

14. The optical position-measuring device as recited in claim 13, wherein the periodic sub-regions of the reference marks have arranged therein a cross grating which, like the surrounding part of the measuring graduation, is configured as a reflection phase grating, both the periodic sub-regions and the aperiodic sub-regions of the reference marks having a reflection-enhancing coating.

15. The optical position-measuring device as recited in claim 1, wherein the aperiodic sub-regions of the reference marks each have chirped grating structures in which grating periods vary spatially symmetrically with respect to a central axis of symmetry.

16. The optical position-measuring device as recited in claim 1, wherein the periodic sub-regions and the aperiodic sub-regions of the reference marks are arranged periodically in a direction perpendicular to one of the measurement directions.

17. The optical position-measuring device as recited in claim 1, wherein the periodic sub-regions and the aperiodic sub-regions of the reference marks have a surface area ratio different from 1:1.

18. The optical position-measuring device as recited in claim 1, wherein the periodic sub-regions of the reference marks have arranged therein one-or two-dimensional periodic grating structures having periodicities along one or both of the first and second measurement directions that are equal to periodicities of the surrounding part of the measuring graduation along the one or both of the first and second measurement directions.
